(19) United States
(12) Patent Application Publication
(10) Pub. No.: US 2015/0058088 A1
(43) Pub. Date: Feb. 26, 2015

(54) METHOD AND SYSTEM FOR USING TRANSACTION DATA TO ASSIGN A TRADE AREA TO A MERCHANT LOCATION

(71) Applicant: MasterCard International Incorporated, Purchase, NY (US)

(72) Inventors: Kenneth UNSER, Fairfield, CT (US); Po Hu, Norwalk, CT (US); Justin X. Howe, Oakdale, NY (US)

(73) Assignee: MasterCard International Incorporated, Purchase, NY (US)

(21) Appl. No.: 13/973,804

(22) Filed: Aug. 22, 2013

(51) Int. Cl. G06Q 30/02

(52) U.S. Cl. CPC G06Q 30/0205
USPC 705/7.34

(57) ABSTRACT

A method for identifying a merchant trade area, includes: receiving a trade area request, the request identifying a merchant; storing a plurality of consumer location data entries, each entry including data related to a consumer involved in one or more payment transactions with the merchant, including a geographic location associated with the related consumer; identifying a geographic location associated with the merchant; identifying at least one geographic deviation metric based on the geographic location associated with the related consumer included in each entry of the plurality of consumer location data entries; identifying a merchant trade area based on the geographic location associated with the merchant and the identified at least one geographic deviation metric; and transmitting the identified merchant trade area in response to the received trade area request.

### FIELD

The present disclosure relates to the identification of merchant trade areas, classifications, and geolocations, specifically the use of consumer transaction and location data to identify merchant locations and corresponding trade areas and classifications.

### BACKGROUND

Merchants may often times try to obtain information regarding their effective trade area. Such information may be used in a number of applications, such as for expanding to a new location, advertising, etc. Methods have been developed to enable Merchants to obtain information in an attempt to estimate their trade area, such as by requesting location information (e.g., zip codes or postal codes) from consumers at the point-of-sale, using address information tied to loyalty or membership cards, etc.

However, these methods often suffer from a number of disadvantages. In many instances, the information may be obtained from a consumer at a point-of-sale, which may take additional time and system resources, which can result in increased expenses and less revenue. In other instances, the information may be obtained from only a small sample of consumers, which may yield inaccurate results. Thus, there is a need for a technical solution that more easily and efficiently provides an accurate trade area for a merchant based on consumer locations.

### SUMMARY

The present disclosure provides a description of systems and methods for identifying merchant trade areas, classifications, and geolocations.

A method for identifying a merchant trade area, includes: receiving, by a receiving device, a trade area request, wherein the trade area request identifies a merchant; storing, in a location database, a plurality of consumer location data entries, wherein each consumer location data entry includes data related to a consumer involved in one or more payment transactions with the merchant, including at least a geographic location associated with the related consumer; identifying, by a processing device, a geographic location associated with the merchant; identifying, by the processing device, at least one geographic deviation metric based on the geographic location associated with the related consumer included in each consumer location data entry of the plurality of consumer location data entries; identifying, by the processing device, a merchant trade area based on the geographic location associated with the merchant and the identified at least one geographic deviation metric; and transmitting, by a transmitting device, the identified merchant trade area in response to the received trade area request.

A method for identifying a merchant geolocation, includes: storing, in a location database, a plurality of consumer location data entries, wherein each consumer location data entry includes data related to a consumer involved in one or more payment transactions with a merchant, including at least a geographic location associated with the related consumer based on the corresponding one or more payment transactions; identifying, by a processing device, a geographic location of the merchant based on the geographic location included in each consumer location data entry of the plurality of consumer location data entries; and associating, in a merchant database, the identified geographic location with the merchant.

A method for identifying a merchant classification includes: storing, in a location database, a plurality of consumer location data entries, wherein each consumer location data entry includes data related to a consumer involved in one or more payment transactions with a merchant, including at least a geographic location associated with the related consumer; identifying, by a processing device, a geographic location associated with the merchant; identifying, by the processing device, at least one geographic deviation metric based on the geographic location associated with the related consumer included in each consumer location data entry of the plurality of consumer location data entries; identifying, by the processing device, a merchant classification based on the identified at least one geographic deviation metric and the identified geographic location associated with the merchant; and associating, by the processing device, the identified merchant classification with the merchant.

A system for identifying a merchant trade area includes a receiving device, a location database, a processing device, and a transmitting device. The receiving device is configured to receive a trade area request, wherein the trade area request identifies a merchant. The location database is configured to store a plurality of consumer location data entries, wherein each consumer location data entry includes data related to a consumer involved in one or more payment transactions with the merchant, including at least a geographic location associated with the related consumer. The processing device is configured to: identify a geographic location associated with the merchant, identify at least one geographic deviation metric based on the geographic location associated with the related consumer included in each consumer location data entry of the plurality of consumer location data entries, and identify a merchant trade area based on the geographic location associated with the merchant and the identified at least one geographic deviation metric. The transmitting device is configured to transmit the identified merchant trade area in response to the received trade area request.

A system for identifying a merchant geolocation includes a merchant database, a location database, and a processing device. The location database is configured to store a plurality of consumer location data entries, wherein each consumer location data entry includes data related to a consumer involved in one or more payment transactions with a merchant, including at least a geographic location associated with the related consumer based on the corresponding one or more payment transactions. The processing device is configured to: identify a geographic location of the merchant based on the geographic location included in each consumer location data entry of the plurality of consumer location data entries; and associate, in the merchant database, the identified geographic location with the merchant.

A system for identifying a merchant classification includes a location database and a processing device. The location database is configured to store a plurality of consumer location data entries, wherein each consumer location data entry includes data related to a consumer involved in one or more payment transactions with a merchant, including at least a geographic location associated with the related consumer. The processing device is configured to: identify a geographic location associated with the merchant; identify at least one geographic deviation metric based on the geographic location associated with the related consumer included in each consumer location data entry of the plurality of consumer location data entries; identify a merchant classification based on the identified at least one geographic deviation metric and the identified geographic location associated with the merchant; and associate the identified merchant classification with the merchant.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying merchant trade areas and geolocations in accordance with exemplary embodiments.

FIG. 2 is a block diagram illustrating the processing server of FIG. 1 for the identification of merchant trade areas and geolocations in accordance with exemplary embodiments.

FIG. 3 is a flow diagram illustrating a method for identifying a merchant trade area in accordance with exemplary embodiments.

FIG. 4 is a flow chart illustrating a method for identifying merchant trade areas and geolocations in accordance with exemplary embodiments.

FIG. 5 is a diagram illustrating the identification of a merchant geolocation based on consumer locations in accordance with exemplary embodiments.

FIGS. 6A and 6B are diagrams illustrating the identification of a merchant trade area based on consumer locations in accordance with exemplary embodiments.

FIG. 7 is a flow chart illustrating an exemplary method for identifying a merchant trade area in accordance with exemplary embodiments.

FIG. 8 is a flow chart illustrating an exemplary method for identifying a merchant geolocation in accordance with exemplary embodiments.

FIG. 9 is a flow chart illustrating an exemplary method for identifying a merchant classification in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes that may connect an issuer that issues payment cards or accounts and an acquirer that acquires transactions details from a merchant in order to process a transaction. Sometimes the merchant acts as its own acquirer and/or issuer, and there may be one or more intermediaries that handle part of the transaction or stand-in for one of the other parties, as appropriate. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, Japan Credit Bureau®, Automated Clearing House, PayPal®, Dwolla®, Bitcoin, etc.

Classification—The process of classifying something according to shared qualities or statistics. In most instances, classification is performed on the basis of a training set of data containing observations or instances whose category membership is known. The individual observations are analyzed to obtain a set of properties (e.g., features, etc.) and then classified based on a category associated with the obtained set of properties.

### System for Providing Privacy Compliant Characteristic Payments Data

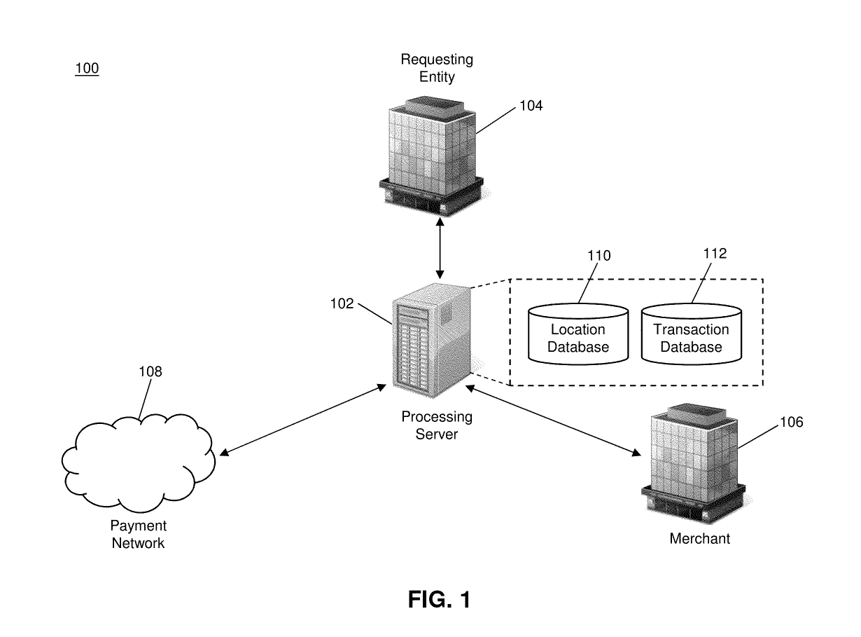

FIG. 1 illustrates a system 100 for identifying merchant trade areas, classifications, and geolocations based on transaction data and consumer location data.

A processing server 102, discussed in more detail below, may receive a request from a requesting entity 104 for a merchant trade area or geolocation. The request may include at least a merchant identifier or other information identifying a merchant 106 for which the trade area and/or geolocation is requested. In some instances, the requesting entity 104 may be the merchant 106, or may be a separate entity, such as an advertiser, offer provider, acquirer, etc.

The processing server 102 may be configured, using methods discussed in more detail below, to identify a trade area or geolocation of the merchant 106 using consumer location and transaction data. The processing server 102 may receive consumer transaction data from a payment network 108, which may be received and then stored in a transaction database 112. The transaction data may include transaction data entries that include data relating to payment transactions including at least a consumer identifier and a merchant identifier. In some instances, the processing server 102 may request transaction data entries from the payment network 108 for payment transactions involving the merchant 106 indicated in the request received from the requesting entity 104.

The processing server 102 may also store consumer location information in a location database 110. The consumer location information may be received from sources that will be apparent to persons having skill in the relevant art, such as the consumers themselves, the payment network 108, a third party (e.g., an issuing bank, a credit reporting agency, a demographics agency, etc.), etc. The consumer location may include a plurality of consumer data entries, each of which may include data relating to a consumer including a consumer identifier and a geographic location associated with the related consumer. The geographic location (“geolocation”) may be a zip code, postal code, street address, or any other suitable value. In some instances, the consumer location information may be such that the related consumer is not personally identifiable based on the information.

In some embodiments, the processing server 102 may be a part of the payment network 108. In such an embodiment, the transaction data stored in the transaction database 112 may correspond to payment transactions processed by the payment network 108. Similarly, in some instances, the location data stored in the location database 110 may correspond to consumers holding payment cards associated with the payment network 108. In such an instance, the processing server 102 may use locally available or internally developed information, and may not need to receive information from external, or third party, sources. Additional configurations of the system 100 and methods for obtaining the consumer location and transaction data will be apparent to persons having skill in the relevant art.

The processing server 102 may, using methods discussed in more detail below, identify the trade area and/or geolocation of the merchant 106 using the location data stored in the location database 110 and the transaction data stored in the transaction database 112. The processing server 102 may then transmit the information to the requesting entity 104 in response to the originally received request.

### Processing Device

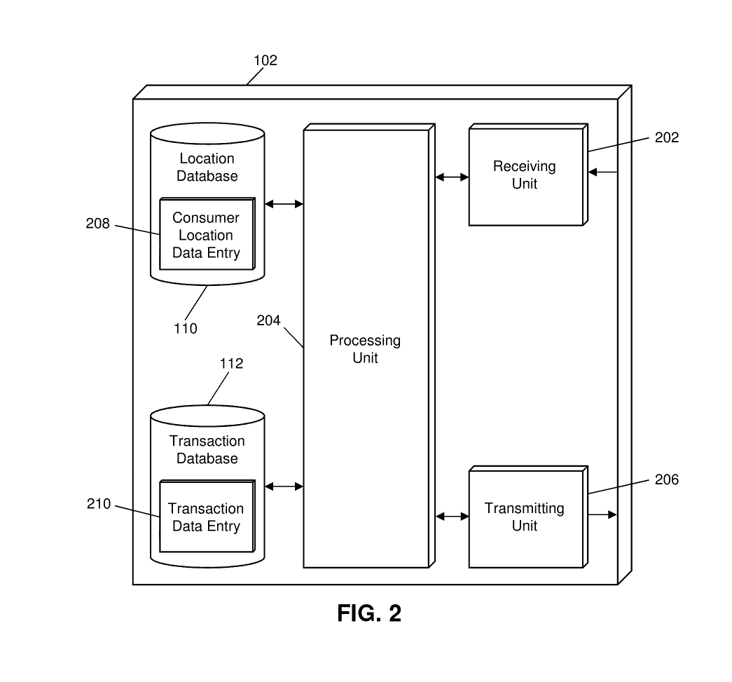

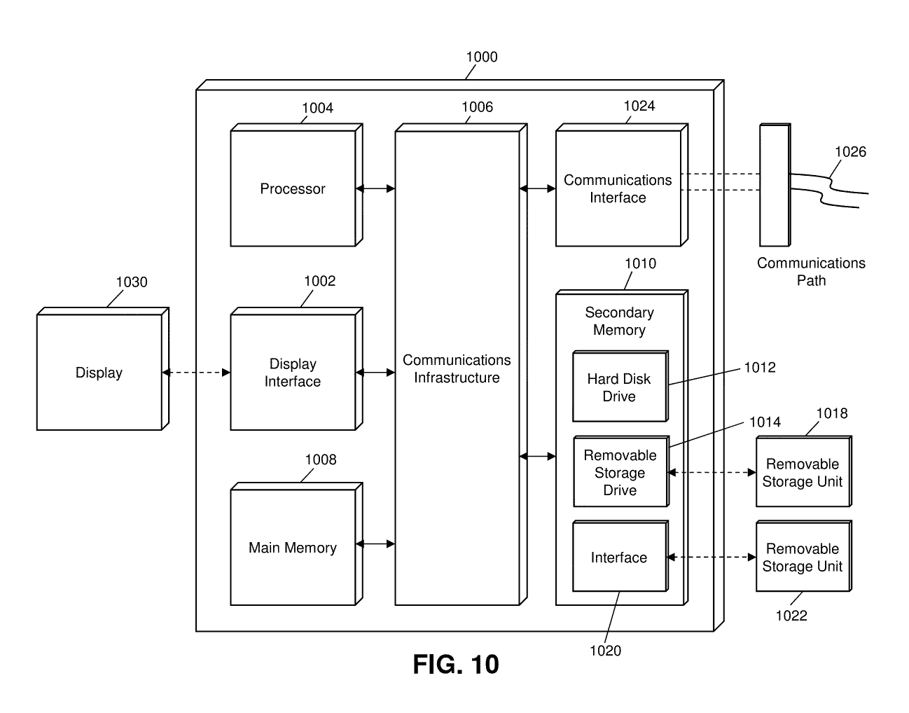

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 1000 illustrated in FIG. 10 and discussed in more detail below may be a suitable configuration of the processing server 102.

The processing server 102 may include a receiving unit 202. The receiving unit 202 may be configured to receive the request for a merchant trade area and/or geolocation from the requesting entity 104. The receiving unit 202 may be configured to communicate with one or more networks via one or more protocols as will be apparent to persons having skill in the relevant art. The receiving unit 202 may also be configured to receive consumer location data and transaction data, such as from the payment network 108, from consumers, from merchants, from third parties, etc.

The processing server 102 may also include a processing unit 204. The processing unit 204 may be configured to store the received consumer location information in the location database 110 as a plurality of consumer location data entries 208. Each consumer location data entry 208 may include data related to a consumer including at least a consumer identifier associated with the related consumer and a geographic location associated with the related consumer. In some embodiments, each consumer location data entry 208 may also include a time and/or date at which the included geographic location was identified. The consumer identifier may be any value suitable for identification of a unique consumer, such as a payment account number, a username, an identification number, an e-mail address, a phone number, etc. The geographic location may be a location associated with the related consumer, which may be represented by latitude and longitude, zip code, postal code, street address, or any other value as will be apparent to persons having skill in the relevant art.

The processing unit 204 may also be configured to store the received transaction data in the transaction database 112 as a plurality of transaction data entries 210. Each transaction data entry 210 may include data relating to a payment transaction including at least a consumer identifier associated with a consumer involved in the related payment transaction, and a merchant identifier associated with a merchant involved in the related payment transaction. The merchant identifier may be any value suitable for the identification of a unique merchant, such as a merchant identification number (MID). In some embodiments, each transaction data entry 210 may also include a time and/or date at which the transaction took place (e.g., was initiated, processed, cleared, etc.).

The processing unit 204 may identify the merchant identifier included in the request received by the receiving unit 202, and then may identify those transaction data entries 210 in the transaction database 112 where the included merchant identifier corresponds to the merchant identifier included in the received request. The processing unit 204 may also be configured to then identify the geographic location of each consumer involved in the identified payment transactions via the included consumer identifiers and their corresponding consumer location data entries 208 included in the location database 110.

Once the processing unit 204 has identified the geographic location for each consumer involved in payment transactions with the requested merchant 106, the processing unit 204 may then identify the trade area, classification, and/or geolocation of the requested merchant 106, as discussed in more detail below. The processing server 102 may also include a transmitting unit 206, which may be configured to transmit the identified trade area and/or geolocation of the merchant 106 to the requesting entity 104 as a response to the originally received request. The transmitting unit 206 may be configured to communicate with the requesting entity 104 and/or any other entities through one or more networks via one or more protocols as will be apparent to persons having skill in the relevant art.

### Processing Flow for Identification of a Merchant Trade Area

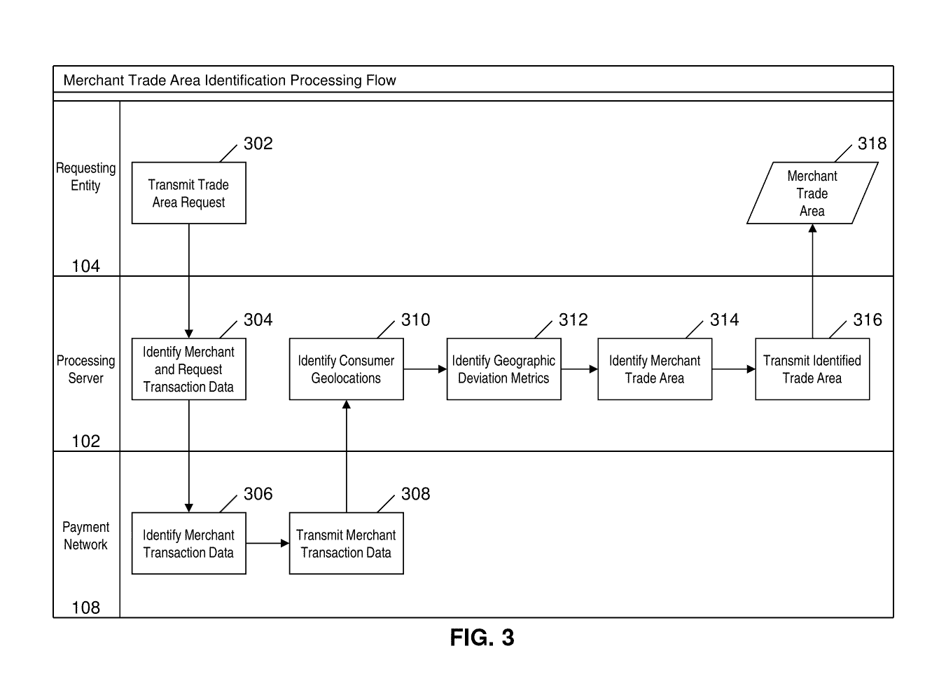

FIG. 3 illustrates a processing flow for the identification of a merchant trade area by the processing server 102 in the system 100.

In step 302, the requesting entity 104 may transmit a trade area request to the processing server 102, wherein the trade area request includes at least a merchant identifier corresponding to the merchant 106. The processing server 102 may receive (e.g., via the receiving unit 202) the request and may, in step 304, identify the merchant identifier included in the request and request transaction data corresponding to the merchant 106 associated with the merchant identifier from the payment network 108.

In step 306, the payment network 108 may receive the request for transaction data, and then may identify transaction data corresponding to the merchant 106. The transaction data may include at least the consumer identifier for each consumer involved in the payment transactions included in the transaction data, and may include additional data as will be apparent to persons having skill in the relevant art. In step 308, the payment network 108 may transmit the identified transaction data to the processing server 102.

In step 310, the processing server 102 may receive the transaction data. The processing unit 204 of the processing server 102 may identify the consumer identifiers included in each payment transaction in the transaction data, and may then identify the corresponding consumer location data entries 208 in the location database 110. The geographic locations included in each of the identified consumer location data entries 208 may then be identified. In step 312, the processing server 102 may identify geographic deviation metrics based on each of the geographic locations. Methods and systems for identifying geographic deviation metrics based on a plurality of geographic locations will be apparent to persons having skill in the relevant art.

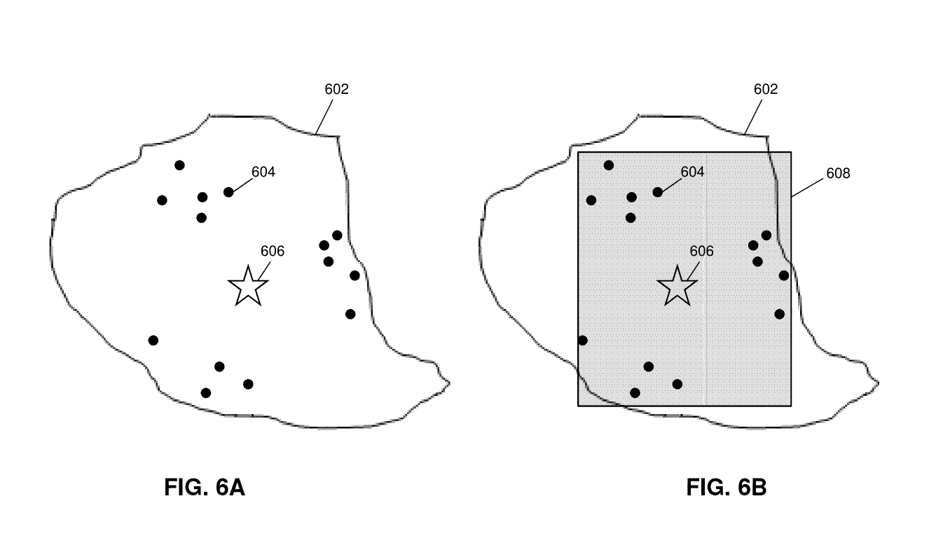

In step 314, the processing server 102 may identify a merchant trade area for the merchant 106 based on the geographic deviation metrics. An example of an identified trade area based on consumer geographic locations is provided in more detail below with respect to FIGS. 6A and 6B. In step 316, the processing server 102 may transmit (e.g., via the transmitting unit 206) the identified merchant trade area to the requesting entity 104. The requesting entity 104 may then receive the requested merchant trade area in step 318.

### Identification of Merchant Geolocations and Trade Areas

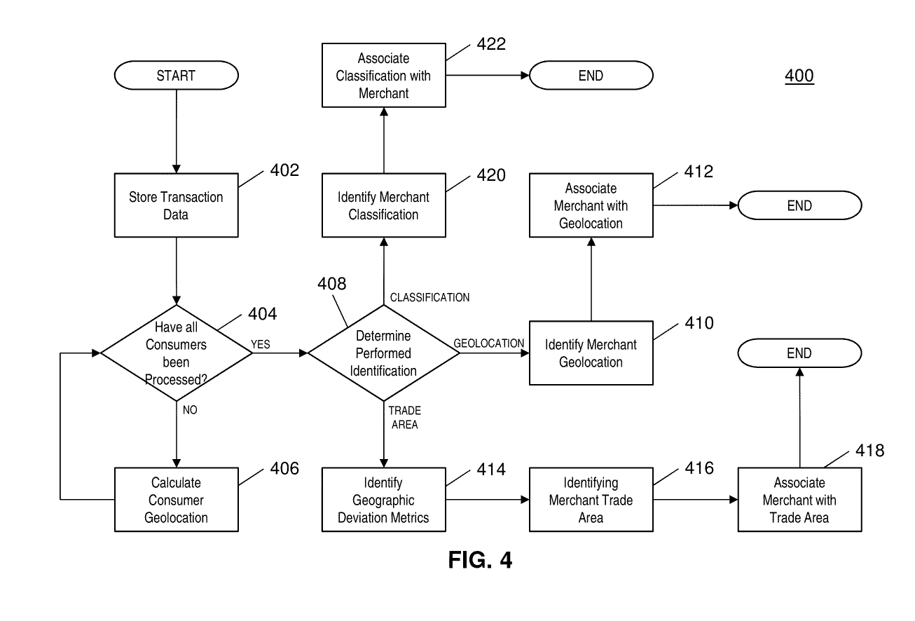

FIG. 4 illustrates a method 400 for identifying a merchant geolocation and/or merchant trade area by the processing server 102.

In step 402, the processing unit 204 may store transaction data corresponding to payment transactions involving a requested merchant (e.g., the merchant 106) in the transaction database 112 as a plurality of transaction data entries 210. In step 404, the processing unit 204 may identify if each of the consumers involved in the payment transactions corresponding to the transaction data have been processed. If there are additional consumers (e.g., consumer identifiers included in the transaction data entries 210) for which geographic locations have not been identified, then, in step 406, the processing unit 204 may identify the geographic location for the respective consumer in the corresponding consumer location data entry 208 in the location database 110.

Once each of the geographic locations have been identified, then, in step 408, the processing unit 204 may determine if the trade area, classification, or the geolocation of the merchant 106 is being identified. If the geographic location of the merchant 106 is to be identified, then, in step 410, the processing unit 204 may identify the geographic location of the merchant 106 based on the geographic locations of the consumers involved in payment transactions with the merchant 106. In an exemplary embodiment, the processing unit 204 may identify the merchant geographic location as a centroid of the consumer geographic locations. Other methods may include calculating a mode, iteratively computed geolocation midpoint, or any other suitable method as will be apparent to persons having skill in the relevant art. In step 412, the identified merchant geolocation may be associated with the merchant 106 and may, in some instances, be transmitted to a third party, such as the requesting entity 104.

If the trade area of the merchant 106 is to be identified, then, in step 414, the processing unit 204 may identify geographic deviation metrics, which may be based on a geographic location (e.g., the merchant street address as provided in the payment transaction, the geocoded merchant street address as provided in the payment transaction, etc.) of the merchant 106. The geographic deviation metrics may include mean geographic distances, standard deviation, clustering of geographic locations, removal of outlier locations, and other methods and metrics that will be apparent to persons having skill in the relevant art. For example, the processing unit 204 may compare every potential value to every other potential value (e.g., using within-cluster variance). In another example, the processing unit 204 may identify a specific point (e.g., the most common zip or postal code, the merchant centroid, etc.) and calculate the deviation of all of the potential points relative to that point.

In step 416, the processing unit 204 may identify the merchant trade area based on the geographic deviation metrics. In some embodiments, the merchant trade area may be based purely on the geographic locations of the consumers. In some embodiments, the trade area may be identified using the giftwrapping algorithm as will be apparent to persons having skill in the relevant art. In step 418, the processing unit 204 may associate the merchant trade area with the merchant 106 and may, in some instances, transmit the merchant trade area to a third party, such as the requesting entity 104.

If, in step 408, the processing unit 204 determines that classification of the merchant 106 is to be identified, then, in step 420, the processing unit 204 may identify a merchant classification of the merchant 106 based on the geographic locations of the consumers. In one embodiment, the merchant classification may also, or alternatively, be based on geographic deviation metrics (e.g., as identified in step 414, discussed above). The merchant 106 may be classified by the processing unit 204 based on the geographic locations of the consumers and/or the geographic deviation metric(s), and a geographic location of the merchant 106.

For example, the merchant 106 may be classified as a centrally billed and/or electronic commerce merchant if the geographic locations of the consumers are beyond a predetermined distance from the merchant 106. The predetermined distance may be a large distance, and in some instances may be based on deviation metrics calculated for other merchants. In another example, the merchant 106 may be classified as being associated with the tourism industry if the consumers are located in another country. Additional classifications based on geographic locations and geographic deviation metrics will be apparent to persons having skill in the relevant art. In some instances, transactions may also be similarly classified, such as by classifying a transaction as an e-commerce transaction if the consumer is located beyond a predetermined distance from the merchant 106. At step 422, the processing unit 204 may associate the identified classification with the merchant 106, and may, in some instances, transmit the classification to a third party, such as the requesting entity 104.

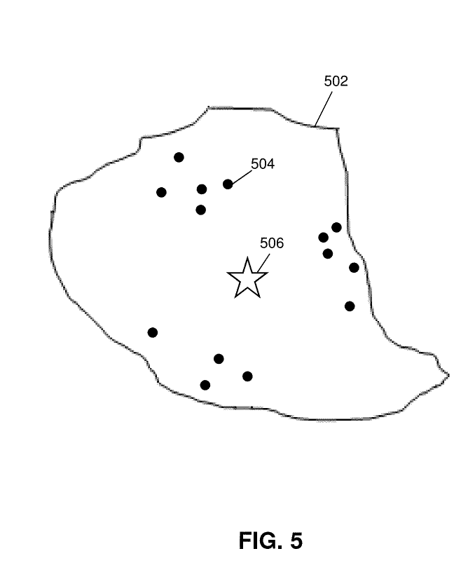

FIG. 5 is an illustration of the identification of a merchant geolocation based on consumer locations. The processing unit 204 may (e.g., in step 402), identify consumer location data entries 208 for consumers who have a geographic location included in a specific geographic area 502 including the merchant 106. It will be apparent to persons having skill in the relevant art that a geographic area 502 may be used to remove outlier geographic locations, or, in other embodiments, all geographic locations may be utilized regardless of geographic area. The geographic area 502 may be a city, state, municipality, or other type of area.

The processing unit 204 may identify a geographic location 504 for each consumer located in the geographic area 502 and involved in a payment transaction with the merchant 106. The processing unit 204 may then calculate the merchant geolocation 506 based on the identified consumer geographic locations 504. As illustrated in FIG. 5, the merchant geolocation 506 may be the centroid of the consumer geographic locations 504, or may be calculated using other suitable methods and systems that will be apparent to persons having skill in the relevant art. In some instances, the merchant geolocation 506 may serve as an approximation of the actual physical location of the merchant 106.

FIGS. 6A and 6B are an illustration of the identification of a merchant trade area based on consumer locations. The processing unit 204 may use geographic locations 604 of consumers in a geographic area 602 that are involved in payment transactions with the merchant 106 for which the trade area is requested. The merchant 106 may be located at a merchant location 606, which may be the physical location of the merchant 106 and/or the merchant geolocation identified as discussed above and illustrated in FIG. 5.

The processing unit 204 may identify geographic deviation metrics based on the geographic locations 604 and the merchant location 606 of the merchant 106, and may then identify a corresponding merchant trade area 608. As illustrated in FIG. 6B, the merchant trade area 608 may, in some instances, encompass the entirety of the geographic locations 604 of the consumers involved in payment transactions with the merchant 106. It should be apparent to persons having skill in the relevant art that the trade area 608 may not include all geographic locations 604, and may not be of any discernible shape, depending on the geographic locations 604 and the metrics and methods used to identify the trade area 608. In some instances, the merchant trade area 608 may be comprised of multiple areas, such as if there were three separate areas encompassing the different sections of geographic locations 604.

The identification of a merchant geolocation 506 and merchant trade area 608 may be useful for a variety of purposes, such as for the distribution of advertisements to consumers, the placement of a competing business or expanded location, the providing of shipping or delivery services, etc. Furthermore, basing the geolocation 506 and trade area 608 on established consumer geographic locations 504 and 604 for consumers involved in payment transactions with the merchant 106 may result in more accurate estimations that may also be obtained more efficiently and using fewer resources.

### Exemplary Method for Identifying a Merchant Trade Area

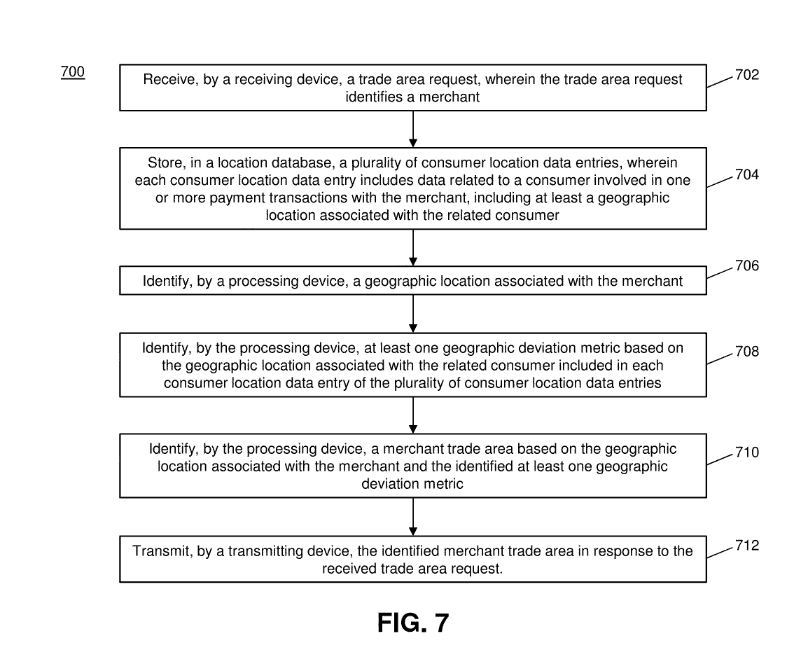

FIG. 7 illustrates an exemplary method 700 for identifying a merchant trade area for a merchant based on consumer geographic locations. In step 702, a trade area request may be received, by a receiving device (e.g., the receiving unit 202), wherein the trade area request identifies a merchant (e.g., the merchant 106).

In step 704, a plurality of consumer location data entries (e.g., the consumer location data entries 208) may be stored in a location database (e.g., the location database 110), wherein each consumer location data entry 208 includes data related to a consumer involved in one or more payment transactions with the merchant 106, including at least a geographic location (e.g., the geographic location 604) associated with the related consumer. In one embodiment, the geographic location 604 associated with the regular consumer may be a centroid calculated based on a location of the one or more payment transactions involving the related consumer. In another embodiment, the geographic location 604 associated with the related consumer is a zip code or postal code calculated based on the location of the one or more payment transactions involving the related consumer. In yet another embodiment, the geographic location 604 may be based on location data received from a mobile communication device associated with the related consumer.

In step 706, a processing device (e.g., the processing unit 204) may identify a geographic location (e.g., the merchant location 606) associated with the merchant 106. In step 708, the processing device 204 may identify at least one geographic deviation metric based on the geographic location 604 associated with the related consumer included in each consumer location data entry 208 of the plurality of consumer location data entries. In one embodiment, the at least one geographic deviation metric may include an estimation of a maximum radius a consumer regularly travels to the geographic location 606 associated with the merchant. In another embodiment, the at least one geographic deviation metric may include a centroid calculated from the geographic locations 604 associated with the related consumers for each consumer location data entry 208 of the plurality of consumer location data entries.

In step 710, the processing device 204 may identify a merchant trade area (e.g., the merchant trade area 608) based on the geographic location 606 associated with the merchant 106 and the identified at least one geographic deviation metric. In step 712, the identified merchant trade area 608 may be transmitted, by a transmitting device (e.g., the transmitting device 206), in response to the received trade area request.

In some embodiments, the method 700 may further include: storing, in a transaction database (e.g., the transaction database 112), a plurality of transaction data entries (e.g., transaction data entries 210), wherein each transaction data entry 210 includes at least a consumer identifier and a geographic location; identifying, by the processing device 204, at least one subset of transaction data entries 210, wherein each transaction data entry 210 in the subset includes a common consumer identifier; identifying, for each subset, a consumer geographic location to be associated with a consumer associated with the respective common consumer identifier, based on the geographic location included in each transaction data entry of the respective subset; and storing, in the location database 110, a location data entry 208 corresponding to each of the at least one subset of transaction data entries, wherein the geographic location 604 included in the stored location data entry 208 corresponds to the identified consumer geographic location.

In a further embodiment, identifying the consumer geographic location may include calculating a centroid based on the geographic location included in each transaction data entry of the respective subset. In another further embodiment, identifying the consumer geographic location may include identifying a zip code or postal code based on the geographic location included in each transaction data entry of the respective subset.

### Exemplary Method for Identifying a Merchant Geolocation

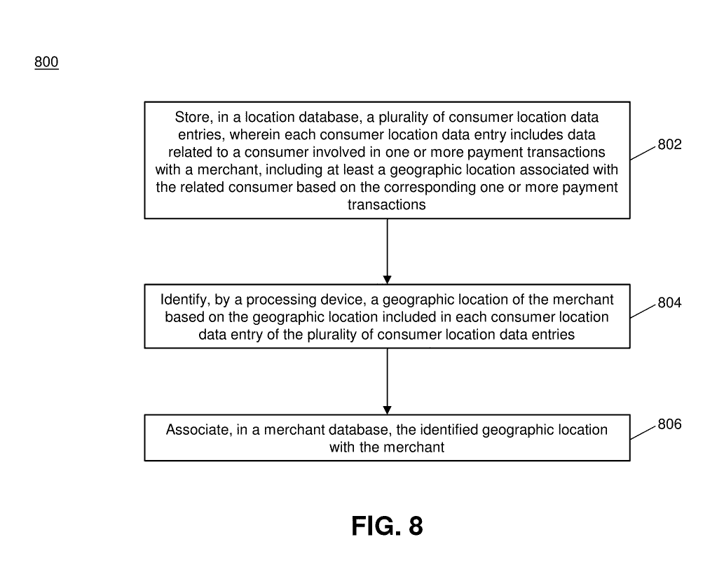

FIG. 8 illustrates an exemplary method 800 for identifying a merchant geolocation based on consumer geographic locations.

In step 802, a plurality of consumer location data entries (e.g., consumer location data entries 208) may be stored in a location database (e.g., the location database 110), wherein each consumer location data entry 208 includes data related to a consumer involved in one or more payment transactions with a merchant (e.g., the merchant 106), including at least a geographic location (e.g., the geographic location 504) associated with the related consumer based on the corresponding one or more payment transactions.

In one embodiment, the geographic location 504 associated with the related consumer may be a centroid calculated from a location of the one or more payment transactions involving the related consumer. In another embodiment, the geographic location 504 associated with the related consumer may be a zip code or a postal code calculated based on a location of the one or more payment transactions involving the related consumer. In yet another embodiment, the geographic location 504 associated with the related consumer may be based on location data received from a mobile communication device associated with the related consumer. In a further embodiment, the location data may be obtained by one of: geographic positioning system, Wi-Fi, cellular network triangulation, and scanning of a machine-readable code at a known geographic location.

In step 804, a processing device (e.g., the processing unit 204) may identify a geographic location (e.g., the geographic location 506) of the merchant 106 based on the geographic location 504 included in each consumer location data entry 208 of the plurality of consumer location data entries. In step 806, the identified geographic location 506 may be associated, in a merchant database, with the merchant 106.

### Exemplary Method for Identifying a Merchant Classification

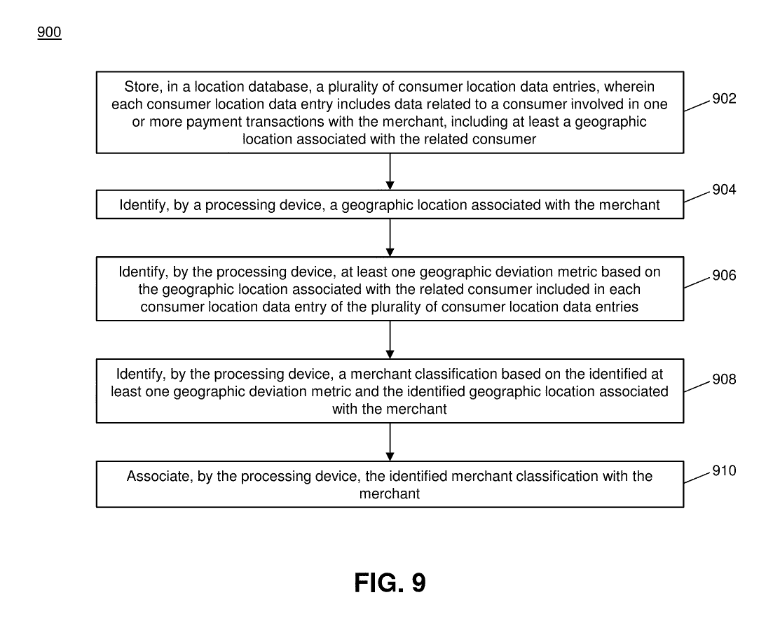

FIG. 9 illustrates an exemplary method 900 for identifying a classification of the merchant 106 by the processing server 102 based on consumer geographic locations.

In step 902, a plurality of consumer location data entries (e.g., consumer location data entries 208) may be stored, in a location database (e.g., the location database 110), wherein each consumer location data entry includes data related to a consumer involved in one or more payment transactions with a merchant (e.g., the merchant 106) including at least a geographic location (e.g., a geographic location 504) associated with the related consumer. In step 904, a processing device (e.g., the processing unit 204) may identify a geographic location (e.g., the geographic location 506) associated with the merchant 106.

In step 906, the processing device 204 may identify at least one geographic deviation metric based on the geographic location 504 associated with the related consumer included in each consumer location data entry 208 of the plurality of consumer location data entries. In step 908, the processing device 204 may identify a merchant classification based on the identified at least one geographic deviation metric and the identified geographic location 506 associated with the merchant 106.

In step 910, the processing device 204 may associate the identified merchant classification with the merchant 106. In some embodiments, the merchant classification may be as a centrally billed and/or electronic commerce (e-commerce) merchant if the identified at least one geographic deviation metric indicates consumers involved with the merchant are beyond a predetermined distance from the identified geographic location associated with the merchant. In a further embodiment, the predetermined distance may be based on geographic deviation metrics for other merchants. In an even further embodiment, the other merchants may be similar or related merchants (e.g., based on industry, category, size, income, etc.). In other embodiments, the merchant classification may be as a tourism merchant if the identified at least one geographic deviation metric indicates consumers involved with the merchant are located in another country from the merchant.

### Computer System Architecture

FIG. 10 illustrates a computer system 1000 in which embodiments of the present disclosure, or portions thereof, may be implemented as computer-readable code. For example, the processing server 102 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 7-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communication infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive, the removable storage unit 1018 may be a floppy disk. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

Computer program medium and computer usable medium may refer to memories, such as the main memory 1008 and secondary memory 1010, which may be memory semiconductors (e.g. DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3, 4, and 7-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for providing characteristic payments data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a merchant trade area, comprising:
receiving, by a receiving device, a trade area request, wherein the trade area request identifies a merchant;
storing, in a location database, a plurality of consumer location data entries, wherein each consumer location data entry includes data related to a consumer involved in one or more payment transactions with the merchant, including at least a geographic location associated with the related consumer;
identifying, by a processing device, a geographic location associated with the merchant;
identifying, by the processing device, at least one geographic deviation metric based on the geographic location associated with the related consumer included in each consumer location data entry of the plurality of consumer location data entries;
identifying, by the processing device, a merchant trade area based on the geographic location associated with the merchant and the identified at least one geographic deviation metric; and
transmitting, by a transmitting device, the identified merchant trade area in response to the received trade area request.

2. The method of claim 1, wherein the at least one geographic deviation metric includes an estimation of a maximum radius a consumer regularly travels to the geographic location associated with the merchant.

3. The method of claim 1, wherein the at least one geographic deviation metric includes or is based on a centroid calculated from the geographic locations associated with the related consumers for each consumer location data entry of the plurality of consumer location data entries.

4. The method of claim 1, wherein the geographic location associated with the related consumer is a centroid calculated based on a location of the one or more payment transactions involving the related consumer.

5. The method of claim 1, wherein the geographic location associated with the related consumer is a zip code or postal code calculated based on a location of the one or more payment transactions involving the related consumer.

6. The method of claim 1, wherein the geographic location associated with the related consumer is based on location data received from a mobile communication device associated with the related consumer.

7. The method of claim 1, further comprising:
storing, in a transaction database, a plurality of transaction data entries, wherein each transaction data entry includes data related to a financial transaction involving the merchant include at least a consumer identifier and a geographic location;
identifying, by the processing device, at least one subset of transaction data entries, wherein each transaction data entry in the subset includes a common consumer identifier;
identifying, for each of the identified at least one subset of transaction data entries, a consumer geographic location to be associated with a consumer associated with the respective common consumer identifier, based on the geographic location included and/or appended in each transaction data entry of the respective subset; and
storing, in the location database, a location data entry corresponding to each of the at least one subset of transaction data entries, wherein the geographic location included in the stored location data entry corresponds to the identified consumer geographic location.

8. The method of claim 7, wherein identifying the consumer geographic location includes calculating a centroid based on the geographic location included in each transaction data entry of the respective subset.

9. The method of claim 7, wherein identifying the consumer geographic location includes identifying a zip code or postal code based on the geographic location included in each transaction data entry of the respective subset.

10. A method for identifying a merchant geolocation, comprising:
storing, in a location database, a plurality of consumer location data entries, wherein each consumer location data entry includes data related to a consumer involved in one or more payment transactions with a merchant, including at least a geographic location associated with the related consumer based on the corresponding one or more payment transactions;
identifying, by a processing device, a geographic location of the merchant based on the geographic location included in each consumer location data entry of the plurality of consumer location data entries; and
associating, in a merchant database, the identified geographic location with the merchant.

11. The method of claim 10, wherein the geographic location associated with the related consumer is a centroid calculated from a location of the one or more payment transactions involving the related consumer.

12. The method of claim 10, wherein the geographic location associated with the related consumer is a zip code or postal code calculated based on a location of the one or more payment transactions involving the related consumer.

13. The method of claim 10, wherein the geographic location associated with the related consumer is based on location data received from a mobile communication device associated with the related consumer.

14. A method for identifying a merchant classification, comprising:
storing, in a location database, a plurality of consumer location data entries, wherein each consumer location data entry includes data related to a consumer involved in one or more payment transactions with a merchant, including at least a geographic location associated with the related consumer;
identifying, by a processing device, a geographic location associated with the merchant;
identifying, by the processing device, at least one geographic deviation metric based on the geographic location associated with the related consumer included in each consumer location data entry of the plurality of consumer location data entries;
identifying, by the processing device, a merchant classification based on the identified at least one geographic deviation metric and the identified geographic location associated with the merchant; and
associating, by the processing device, the identified merchant classification with the merchant.

15. The method of claim 14, wherein the identified merchant classification is an centrally billed and/or electronic-commerce classification if the identified at least one geographic deviation metric indicates consumers involved with the merchant being beyond a predetermined distance from the identified geographic location associated with the merchant.

16. The method of claim 14, wherein the identified merchant classification is a tourism related business if the identified at least one geographic deviation metric indicates consumers involved with the merchant being located in another country from the merchant.

17. A system for identifying a merchant trade area, comprising:
a receiving device configured to receive a trade area request, wherein the trade area request identifies a merchant;
a location database configured to store a plurality of consumer location data entries, wherein each consumer location data entry includes data related to a consumer involved in one or more payment transactions with the merchant, including at least a geographic location associated with the related consumer;
a processing device configured to
identify a geographic location associated with the merchant,
identify at least one geographic deviation metric based on the geographic location associated with the related consumer included in each consumer location data entry of the plurality of consumer location data entries, and
identify a merchant trade area based on the geographic location associated with the merchant and the identified at least one geographic deviation metric; and
a transmitting device configured to transmit the identified merchant trade area in response to the received trade area request.

18. The system of claim 17, wherein the at least one geographic deviation metric includes an estimation of a maximum radius a consumer regularly travels to the geographic location associated with the merchant.

19. The system of claim 17, wherein the at least one geographic deviation metric includes or is based on a centroid calculated from the geographic locations associated with the related consumers for each consumer location data entry of the plurality of consumer location data entries.

20. The system of claim 17, wherein the geographic location associated with the related consumer is a centroid calculated based on a location of the one or more payment transactions involving the related consumer.

21. The system of claim 17, wherein the geographic location associated with the related consumer is a zip code or postal code calculated based on a location of the one or more payment transactions involving the related consumer.

22. The system of claim 17, wherein the geographic location associated with the related consumer is based on location data received from a mobile communication device associated with the related consumer.

23. The system of claim 17, further comprising:
a transaction database configured to store a plurality of transaction data entries, wherein each transaction data entry includes data related to a financial transaction involving the merchant include at least a consumer identifier and a geographic location, wherein
the processing device is further configured to
identify at least one subset of transaction data entries, wherein each transaction data entry in the subset includes a common consumer identifier,
identify, for each of the identified at least one subset of transaction data entries, a consumer geographic location to be associated with a consumer associated with the respective common consumer identifier, based on the geographic location included and/or appended in each transaction data entry of the respective subset, and
store, in the location database, a location data entry corresponding to each of the at least one subset of transaction data entries, wherein the geographic location included in the stored location data entry corresponds to the identified consumer geographic location.

24. The system of claim 23, wherein identifying the consumer geographic location includes calculating a centroid based on the geographic location included in each transaction data entry of the respective subset.

25. The system of claim 23, wherein identifying the consumer geographic location includes identifying a zip code or postal code based on the geographic location included in each transaction data entry of the respective subset.

26. A system for identifying a merchant geolocation, comprising:
a merchant database;
a location database configured to store a plurality of consumer location data entries, wherein each consumer location data entry includes data related to a consumer involved in one or more payment transactions with a merchant, including at least a geographic location associated with the related consumer based on the corresponding one or more payment transactions; and
a processing device configured to
identify a geographic location of the merchant based on the geographic location included in each consumer location data entry of the plurality of consumer location data entries, and
associate, in the merchant database, the identified geographic location with the merchant.

27. The system of claim 26, wherein the geographic location associated with the related consumer is a centroid calculated from a location of the one or more payment transactions involving the related consumer.

28. The system of claim 26, wherein the geographic location associated with the related consumer is a zip code or postal code calculated based on a location of the one or more payment transactions involving the related consumer.

29. The system of claim 26, wherein the geographic location associated with the related consumer is based on location data received from a mobile communication device associated with the related consumer.

30. A system for identifying a merchant classification, comprising:
a location database configured to store a plurality of consumer location data entries, wherein each consumer location data entry includes data related to a consumer involved in one or more payment transactions with a merchant, including at least a geographic location associated with the related consumer; and
a processing device configured to
identify a geographic location associated with the merchant,
identify at least one geographic deviation metric based on the geographic location associated with the related consumer included in each consumer location data entry of the plurality of consumer location data entries,
identify a merchant classification based on the identified at least one geographic deviation metric and the identified geographic location associated with the merchant, and
associate the identified merchant classification with the merchant.

31. The system of claim 31, wherein the identified merchant classification is an centrally billed and/or electronic-commerce classification if the identified at least one geographic deviation metric indicates consumers involved with the merchant being beyond a predetermined distance from the identified geographic location associated with the merchant.

32. The system of claim 32, wherein the identified merchant classification is a tourism related business if the identified at least one geographic deviation metric indicates consumers involved with the merchant being located in another country from the merchant.
